(19) United States
(12) Patent Application Publication
(10) Pub. No.: US 2023/0198047 A1
(43) Pub. Date: Jun. 22, 2023

(54) Composite Pad and Battery Module Including the Same

(71) Applicant: SK On Co., Ltd., Seoul (KR)

(72) Inventors: Jeong Tae HWANG, Daejeon (KR); Jung Hyun SEO, Daejeon (KR); Eun Sam CHO, Daejeon (KR); Ju Young CHOI, Daejeon (KR)

(21) Appl. No.: 18/068,548

(22) Filed: Dec. 20, 2022

(30) Foreign Application Priority Data
Dec. 20, 2021 (KR) 10-2021-0183161

(51) Int. Cl. H01M 10/6555; H01M 50/209

(52) U.S. Cl. CPC H01M 10/6555; H01M 50/209

(57) ABSTRACT

A composite pad and a battery module including the same are disclosed. The composite pad is a pad including a first pad surface and a second pad surface positioned opposite the first pad surface. The composite pad includes a pad body with elasticity, and a heat conduction part with thermal conductivity coupled to the pad body and connected to an edge of the pad. The pad body forms at least a portion of the first pad surface and forms at least a portion of the second pad surface.

### CROSS-REFERENCE TO RELATED APPLICATIONS

This application claims the priority benefit of Korean Patent Application No. 10-2021-0183161 filed on Dec. 20, 2021, which is incorporated herein by reference for all purposes as if fully set forth herein.

### TECHNICAL FIELD

The present disclosure relates to a composite pad and a battery module including the same. More particularly, the present disclosure relates to a composite pad that has both elastic and thermal conductive properties, is positioned between a plurality of battery cells, and increases stability and cooling efficiency, and a battery module including the composite pad.

### BACKGROUND

A related art battery module may buffer swelling of a battery cell due to swelling by disposing an elastic pad between a plurality of battery cells. A separate cooling member may be disposed between the battery cells to cool the battery cells. The cooling member may be a heat conductive adhesive or the like, and may be formed by being applied to the battery cell.

In this case, since the elastic pad and the cooling member have to be interposed between the plurality of battery cells, a manufacturing process may be complicated and an overall volume of the battery module may be increased. Hence, there may be a need to develop a pad, in which the elastic pad and the cooling member are effectively coupled, and a battery module including the pad.
(Patent Document 1) KR 10-2128588 B1

### SUMMARY

An object of the present disclosure is to address the above-described and other problems.

Another object of the present disclosure is to provide a composite pad with both elasticity and thermal conductivity and a battery module including the composite pad.

Another object of the present disclosure is to provide a composite pad in which a pad body with elasticity included in the composite pad forms at least a portion of each of one surface and other surface of the composite pad, and a battery module including the composite pad.

Another object of the present disclosure is to provide a slim composite pad and a battery module including the same.

Another object of the present disclosure is to provide a battery module with improved space efficiency.

In order to achieve the above-described and other objects and needs, in one aspect of the present disclosure, there is provided a composite pad that is a pad including a first pad surface and a second pad surface positioned opposite the first pad surface, the composite pad comprising a pad body with elasticity, and a heat conduction part with thermal conductivity coupled to the pad body and connected to an edge of the pad, wherein the pad body forms at least a portion of the first pad surface and forms at least a portion of the second pad surface.

In another aspect of the present disclosure, there is provided a cell assembly comprising a plurality of battery cells; and a pad disposed between the plurality of battery cells, the pad including a first pad surface and a second pad surface positioned opposite the first pad surface, wherein the pad includes a pad body with an elasticity; and a heat conduction part coupled to the pad body and connected to an edge of the pad, the heat conduction part having a thermal conductivity, wherein the pad body forms at least a portion of the first pad surface, and wherein the pad body forms at least a portion of the second pad surface.

In another aspect of the present disclosure, there is provided a battery module comprising a battery group including a plurality of battery cells; a housing configured to accommodate the battery group; and a pad disposed between the plurality of battery cells, the pad including a first pad surface and a second pad surface positioned opposite the first pad surface, wherein the pad includes a pad body with an elasticity, the pad body being configured to form at least a portion of the first pad surface and form at least a portion of the second pad surface; and a heat conduction part coupled to the pad body and connected to an edge of the pad, the heat conduction part having a thermal conductivity.

Effects of the composite pad and the battery module including the same according to the present disclosure are described as follows.

According to at least one aspect of the present disclosure, the present disclosure can provide a composite pad with both elasticity and thermal conductivity and a battery module including the composite pad.

According to at least one aspect of the present disclosure, the present disclosure can provide a composite pad in which a pad body with elasticity included in the composite pad forms at least a portion of each of one surface and other surface of the composite pad, and a battery module including the composite pad.

According to at least one aspect of the present disclosure, the present disclosure can provide a slim composite pad and a battery module including the same.

According to at least one aspect of the present disclosure, the present disclosure can provide a battery module with improved space efficiency.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a battery module according to an embodiment of the present disclosure.

FIG. 2 is an exploded perspective view of a battery module of FIG. 1.

FIG. 3 illustrates a bottom plate according to an embodiment of the present disclosure.

FIG. 4 illustrates a cross section taken along A1-A2 of a battery module of FIG. 1.

FIG. 5 enlargedly illustrates a part B of FIG. 4.

FIG. 6 illustrates an arrangement of a housing and a plurality of pads.

FIG. 7 illustrates a pad.

FIG. 8 illustrates a surface of a pad according to an embodiment of the present disclosure.

FIGS. 9A to 9C illustrate a cross section taken along C1-C2 of a pad of FIG. 8.

FIG. 10 illustrates a pad including a horizontal heat conduction part.

FIGS. 11A and 11B illustrate a cross section taken along D1-D2 of a pad of FIG. 10.

FIG. 12 illustrates a pad in which a horizontal heat conduction part and a vertical heat conduction part intersect each other.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

In the drawings, sizes of the components may be exaggerated or reduced for convenience of explanation. For example, the size and the thickness of each component illustrated in the drawings are arbitrarily illustrated for convenience of explanation, and thus the present disclosure is not limited thereto unless specified as such.

If any embodiment is implementable differently, a specific order of processes may be performed differently from the order described. For example, two consecutively described processes may be performed substantially at the same time, or performed in the order opposite to the described order.

In the following embodiments, when layers, areas, components, etc. are connected, the following embodiments include both the case where layers, areas, and components are directly connected, and the case where layers, areas, and components are indirectly connected to other layers, areas, and components intervening between them. For example, when layers, areas, components, etc. are electrically connected, the present disclosure includes both the case where layers, areas, and components are directly electrically connected, and the case where layers, areas, and components are indirectly electrically connected to other layers, areas, and components intervening between them.

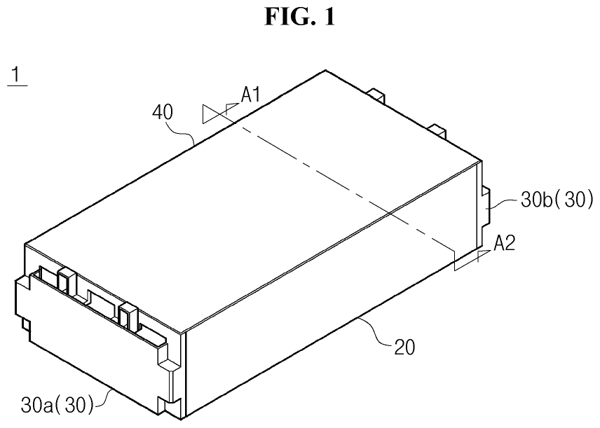

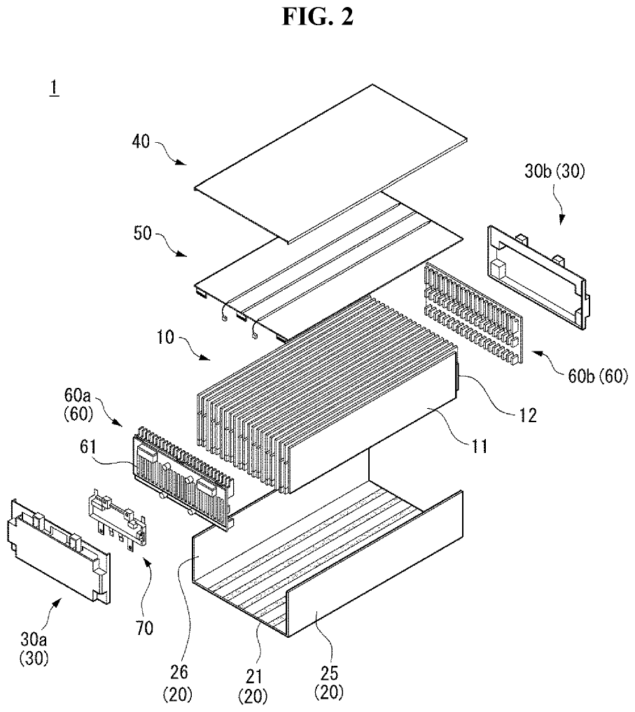

FIG. 1 illustrates a battery module 1 according to an embodiment of the present disclosure. FIG. 2 is an exploded perspective view of the battery module 1 of FIG. 1.

Referring to FIGS. 1 and 2, the battery module 1 may include a housing 20. The housing 20 may form an upwardly open shape. The housing 20 may have an open shape in front-rear. The housing 20 may form an accommodation space. In other words, the accommodation space formed in the housing 20 may be opened up and back and forth.

The housing 20 may include a bottom plate 21. The bottom plate 21 may form a bottom of the housing 20. An upper face of the bottom plate 21 may face the accommodation space formed in the housing 20. A lower face of the bottom plate 21 may exchange heat with an external cooling device. For example, the lower face of the bottom plate 21 may exchange heat with a coolant of the external cooling device. The bottom plate 21 may be referred to as a “cooling plate”.

The bottom plate 21 may be formed of a material with high thermal conductivity. For example, the bottom plate 21 may be formed of a material including aluminum. For example, the bottom plate 21 may easily dissipate heat generated in a battery group 10 to the outside.

The housing 20 may include side plates 25 and 26. The side plates 25 and 26 may include a first side plate 25 and a second side plate 26. The side plates 25 and 26 may indicate at least one of the first side plate 25 and the second side plate 26.

The side plates 25 and 26 may be formed as a unibody with the bottom plate 21. For example, the side plates 25 and 26 and the bottom plate 21 may be formed as a unibody through an extrusion process, etc.

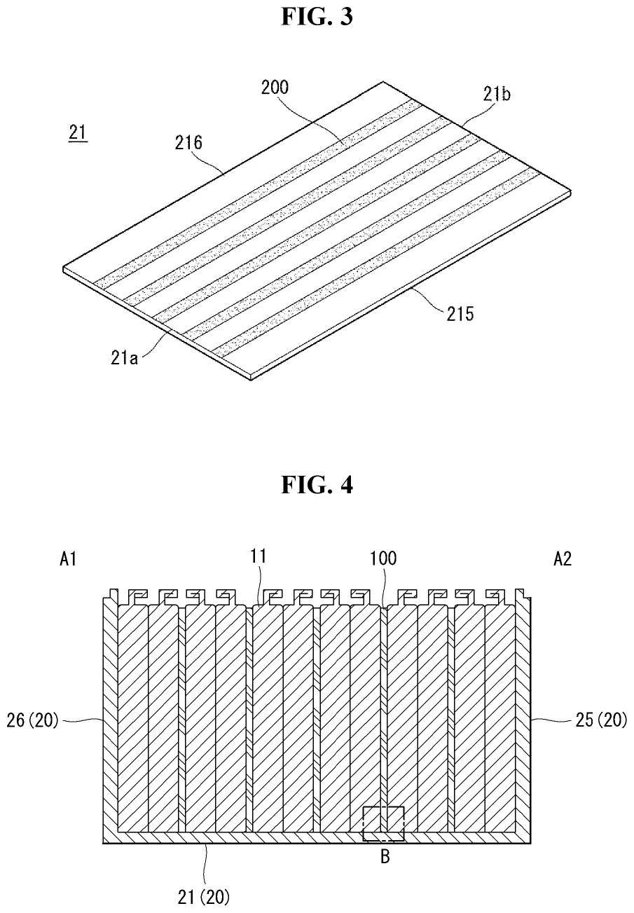

The side plates 25 and 26 may be formed to extend upwardly from the bottom plate 21. For example, the side plates 25 and 26 may form a shape extending upwardly from both sides of the bottom plate 21. For example, the first side plate 25 may form a shape extending upwardly from a first side 215 (see FIG. 3) of the bottom plate 21. For example, the second side plate 26 may form a shape extending upwardly from a second side 216 (see FIG. 3) of the bottom plate 21. The first side 215 (see FIG. 3) of the bottom plate 21 may be positioned opposite the second side 216 (see FIG. 3) of the bottom plate 21.

The side plates 25 and 26 may be formed of a material including a thermal insulation material. For example, the side plates 25 and 26 may minimize a temperature deviation between a plurality of battery cells 11.

The battery module 1 may include the battery group 10. The battery group 10 may include the plurality of battery cells 11. The battery group 10 may be formed by stacking the plurality of battery cells 11. The battery group 10 may be accommodated in the housing 20. For example, the battery group 10 may be positioned on the bottom plate 21. For example, the battery group 10 may be positioned between the first side plate 25 and the second side plate 26.

The plurality of battery cells 11 may be consecutively disposed. For example, the plurality of battery cells 11 may be consecutively disposed between the first side plate 25 and the second side plate 26. For example, the first side plate 25, the plurality of battery cells 11, and the second side plate 26 may be sequentially disposed. A pad 100 (see FIG. 4) may be positioned between the plurality of battery cells 11. The plurality of battery cells 11 and the pad 100 (see FIG. 4) may be referred to as a cell assembly. For example, the cell assembly may include the plurality of battery cells 11 and the pad 100 (see FIG. 4).

The battery cell 11 may indicate one of the plurality of battery cells 11. The battery cell 11 may form a shape that extends from its one end and leads to its other end. The battery cell 11 may include an electrode tab 12. The electrode tab 12 may be positioned at one end and other end of the battery cell 11. One end and other end of the battery cell 11 may indicate one end and other end of the battery group 10, respectively. The electrode tab 12 positioned at one end of the battery cell 11 may be referred to as a “first electrode tab”. The electrode tab 12 positioned at other end of the battery cell 11 may be referred to as a “second electrode tab”.

The battery module 1 may include a cover part 30. The cover part 30 may be coupled to the housing 20. The cover part 30 may cover the accommodation space formed in the housing 20. For example, the cover part 30 may cover an upper side and front and rear sides of the housing 20.

The cover part 30 may include a front cover part 30a. The front cover part 30a may be coupled or connected to a front end of the housing 20. The front cover part 30a may face one end of the battery group 10.

The cover part 30 may include a rear cover part 30b. The rear cover part 30b may be coupled or connected to a rear end of the housing 20. The rear cover part 30b may face other end of the battery group 10.

The cover part 30 may include an upper cover part 30c. The upper cover part 30c may be coupled or connected to an upper end of the housing 20. The upper cover part 30c may face an upper end of the battery group 10. The upper cover part 30c may be coupled or connected to the front cover part 30a and the rear cover part 30b.

The battery module 1 may include a busbar assembly 60. A plurality of bus bar assemblies 60 may be provided. For example, the bus bar assembly 60 may include a first bus bar assembly 60a and a second bus bar assembly 60b. The bus bar assembly 60 may indicate at least one of the first bus bar assembly 60a and the second bus bar assembly 60b.

The first bus bar assembly 60a may be positioned between the front cover part 30a and the battery group 10. The first bus bar assembly 60a may be coupled or connected to the first electrode tabs 12 of the plurality of battery cells 11.

The second bus bar assembly 60b may be positioned between the rear cover part 30b and the battery group 10. The second bus bar assembly 60b may be coupled or connected to the second electrode tabs 12 of the plurality of battery cells 11.

The bus bar assembly 60 may include a plurality of slits 61. The electrode tabs 12 of the plurality of battery cells 11 may be inserted into the plurality of slits 61. The number of the plurality of slits 61 may correspond to the number of electrode tabs 12.

The battery module 1 may include a sensor assembly 50. The sensor assembly 50 may be positioned between the upper cover part 30c and the battery group 10. The sensor assembly 50 may have a plate shape. The sensor assembly 50 may cover the battery group 10.

The sensor assembly 50 may be connected to the busbar assembly 60. For example, one end of the sensor assembly 50 may be connected to the first bus bar assembly 60a. For example, other end of the sensor assembly 50 may be connected to the second bus bar assembly 60b. The sensor assembly 50 may electrically connect the first busbar assembly 60a and the second busbar assembly 60b.

The battery module 1 may include a sensor substrate 70. The sensor substrate 70 may be positioned between the bus bar assembly 60 and the cover part 30. For example, the sensor substrate 70 may be positioned between the first bus bar assembly 60a and the front cover part 30a.

The sensor substrate 70 may be connected to the busbar assembly 60. For example, the sensor substrate 70 may be connected to the first busbar assembly 60a. The sensor substrate 70 may receive an electrical signal from the busbar assembly 60. The sensor substrate 70 may acquire information about a voltage state of the battery group 10.

FIG. 3 illustrates a bottom plate according to an embodiment of the present disclosure.

Referring to FIG. 3, the upper face of the bottom plate 21 can be observed. A heat transfer part 200 may be positioned on the upper face of the bottom plate 21. In FIG. 3, a remainder except for the heat transfer part 200 may indicate the bottom plate 21. The bottom plate 21 may form a shape of a panel or a plate. The bottom plate 21 may form a plurality of edges.

For example, the bottom plate 21 may include a front bottom edge 21a and a rear bottom edge 21b. The front bottom edge 21a may be positioned opposite the rear bottom edge 21b. The front bottom edge 21a and the rear bottom edge 21b may form a portion of a perimeter of the bottom plate 21.

The front bottom edge 21a may form a front end of the bottom plate 21. The rear bottom edge 21b may form a rear end of the bottom plate 21. The bottom plate 21 may form a shape that extends rearward from the front bottom edge 21a and leads to the rear bottom edge 21b.

For example, the bottom plate 21 may include a first bottom edge 215 and a second bottom edge 216. The first bottom edge 215 may face the second bottom edge 216. The first bottom edge 215 may be positioned opposite the second bottom edge 216. The first bottom edge 215 and the second bottom edge 216 may form other portion of the perimeter of the bottom plate 21.

The first bottom edge 215 and the second bottom edge 216 may connect the front bottom edge 21a and the rear bottom edge 21b. The first bottom edge 215 may extend from one end of the front bottom edge 21a and lead to one end of the rear bottom edge 21b. The second bottom edge 216 may extend from other end of the front bottom edge 21a and lead to other end of the rear bottom edge 21b.

The first bottom edge 215 and the second bottom edge 216 may be connected or coupled to the side plates 25 and 26 (see FIG. 2). For example, the first side plate 25 (see FIG. 2) may form a shape extending upwardly from the first bottom edge 215. For example, the second side plate 26 (see FIG. 2) may form a shape extending upwardly from the second bottom edge 216.

The heat transfer part 200 may be formed or positioned on one face of the bottom plate 21. For example, the heat transfer part 200 may be formed or positioned on the upper face of the bottom plate 21. The heat transfer part 200 may be positioned between the bottom plate 21 and the battery group 10 (see FIG. 2).

For example, the heat transfer part 200 may include a filler or a gap filler with excellent thermal conductivity. The heat transfer part 200 may include a heat conductive material. For example, the heat transfer part 200 may include a heat conductive resin. For example, the heat transfer part 200 may include a heat conductive adhesive. For example, the heat transfer part 200 may include at least one of an acrylic-based resin, a urethane-based resin, an epoxy-based resin, an olefin-based resin, and a silicone-based resin.

For example, the heat transfer part 200 may connect or couple the bottom plate 21 and the battery group 10 (see FIG. 2). As another example, the heat transfer part 200 may connect or couple the pad 100 (see FIG. 4) and the bottom plate 21.

The heat transfer part 200 may be positioned on the upper face of the bottom plate 21. For example, the heat transfer part 200 may be distributed on the entire upper face of the bottom plate 21. As another example, the heat transfer part 200 may be distributed on a portion of the upper face of the bottom plate 21. For example, an area of the bottom plate 21 in which the heat transfer part 200 is distributed may correspond to a position of the pad 100 (see FIG. 4).

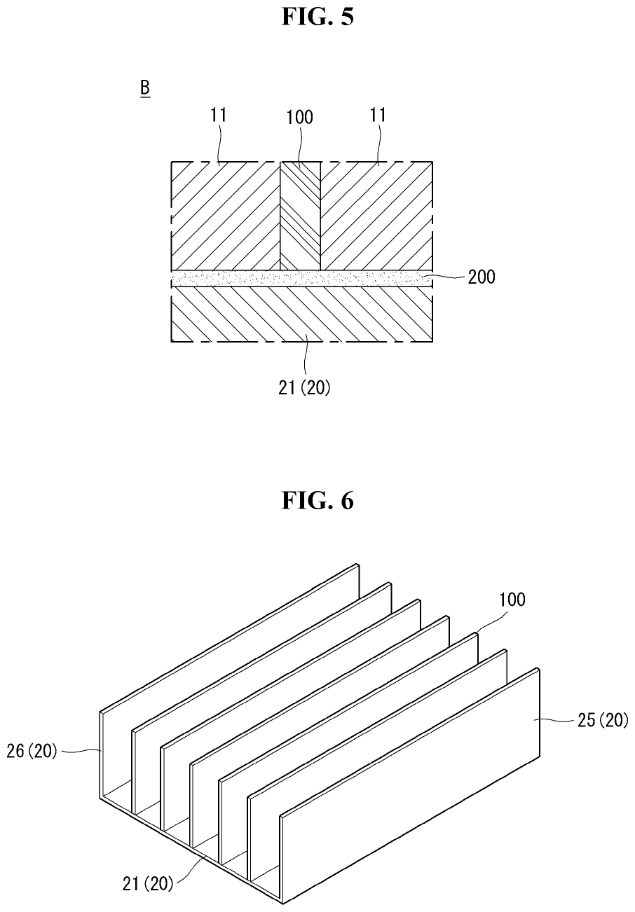

FIG. 4 illustrates a cross section taken along A1-A2 of the battery module 1 of FIG. 1. In FIG. 4, the upper cover part 30c (see FIG. 2) may be omitted for convenience of explanation. FIG. 5 enlargedly illustrates a part B of FIG. 4.

Referring to FIGS. 4 and 5, the battery module 1 may include the pad 100. A plurality of pads 100 may be provided. The pad 100 may indicate at least one of the plurality of pads 100.

The plurality of pads 100 and the plurality of battery cells 11 may be disposed between the first side plate 25 and the second side plate 26. For example, the plurality of pads 100 and the plurality of battery cells 11 may be disposed to be stacked in one direction.

For example, the pad 100 may be disposed between a pair of battery cells 11 and another pair of battery cells 11 adjacent thereto. As another example, the pad 100 may be disposed between one battery cell 11 and another battery cell 11 adjacent thereto.

The pad 100 may have elasticity. For example, the pad 100 may be formed of a material including a resin. For example, the pad 100 may be formed of a material including urethane. When the battery cell 11 swells due to over-heating, etc., a pressure may be applied to another battery cell 11 adjacent to the swollen battery cell 11. The pad 100 may buffer the pressure applied to the battery cell 11. In this context, the pad 100 may be referred to as an “elastic pad”. The pad 100 may be an electrically insulator.

The pad 100 may have thermal conductivity. For example, the pad 100 may include a heat conductive resin. For example, the pad 100 may include a gap filler. For example, the pad 100 may include at least one of a silicone-based resin and a polyurethane resin. In this context, the pad 100 may be referred to as a “heat conductive pad”. The pad 100 may be referred to as a “composite pad” in that it can have both elasticity and thermal conductivity.

The pad 100 may be connected to the bottom plate 21. For example, the heat transfer part 200 may connect the pad 100 and the bottom plate 21. The heat transfer part 200 may be positioned between the pad 100 and the bottom plate 21. The heat transfer part 200 may be coupled or attached to each of the pad 100 and the bottom plate 21.

Heat generated in the battery cell 11 may be transferred to the pad 100. The pad 100 may transfer at least a portion of the heat received from the battery cell 11 to the heat transfer part 200. The heat transfer part 200 may transfer, to the bottom plate 21, at least a portion of heat received from at least one of the pad 100 and the battery cell 11.

FIG. 6 illustrates an arrangement of the housing 20 and the plurality of pads 100.

Referring to FIG. 6, the plurality of pads 100 may be spaced apart from each other. For example, the plurality of pads 100 may be sequentially disposed at regular intervals. The plurality of pads 100 may be disposed between the first side plate 25 and the second side plate 26. For example, the first side plate 25, the plurality of pads 100, and the second side plate 26 may be sequentially disposed.

The pad 100 may form the shape of a panel or a plate. One surface of the pad 100 may face the first side plate 25, and other surface of the pad 100 may face the second side plate 25. Among the two adjacent pads 100, one surface of one pad 100 may face the other surface of the other pad 100.

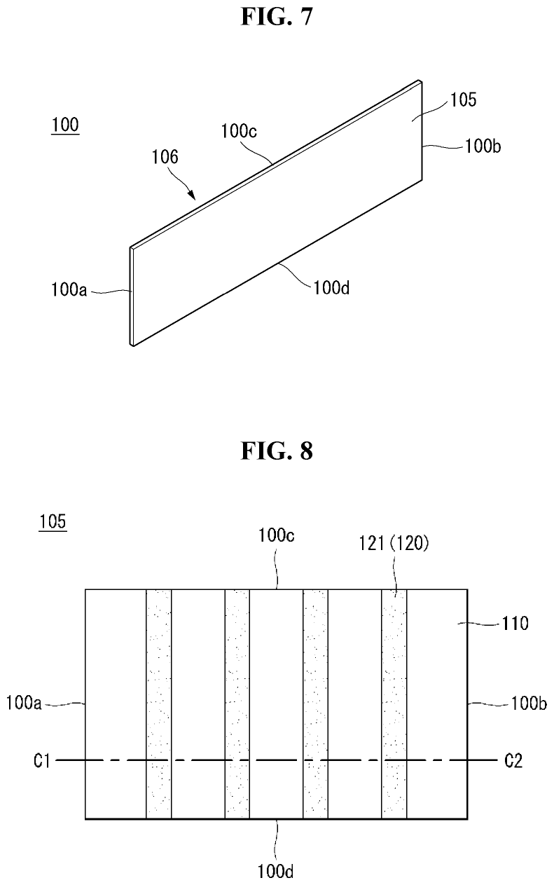

FIG. 7 illustrates the pad 100.

Referring to FIGS. 6 and 7, the pad 100 may form a shape that extends from its one end and leads to its other end. One end of the pad 100 may be adjacent to one end of the housing 20. For example, one end of the pad 100 may be adjacent to one end of the bottom plate 21. For example, one end of the pad 100 may be directed toward or may face the front cover part 30a (see FIGS. 1 and 2). For example, one end of the pad 100 may be directed toward or may face the first bus bar assembly 60a (see FIG. 2).

The other end of the pad 100 may be adjacent to the other end of the housing 20. For example, the other end of the pad 100 may be adjacent to the other end of the bottom plate 21. For example, the other end of the pad 100 may be directed toward or may face the rear cover part 30b (see FIGS. 1 and 2). For example, the other end of the pad 100 may be directed toward or may face the second bus bar assembly 60b (see FIG. 2).

The pad 100 may form both surfaces. For example, a first pad surface 105 of the pad 100 may be one surface of the pad 100. For example, a second pad surface 106 of the pad 100 may be other surface of the pad 100. The first pad surface 105 may be directed toward or may face the first side plate 25 (see FIG. 2). The second pad surface 106 may be directed toward or may face the second side plate 26 (see FIG. 2).

The pad 100 may form a plurality of edges. A plurality of edges 100a, 100b, 100c, and 100d of the pad 100 may form a perimeter of the pad 100. For example, the perimeter of the pad 100 may include the plurality of edges 100a, 100b, 100c, and 100d.

For example, the plurality of edges 100a, 100b, 100c, and 100d may form a perimeter of the first pad surface 105. For example, the plurality of edges 100a, 100b, 100c, and 100d may form a perimeter of the second pad surface 106.

The plurality of edges 100a, 100b, 100c, and 100d may include a first pad edge 100a. The first pad edge 100a may form one end of the pad 100. For example, the first pad edge 100a may form a front end of the pad 100. The first pad edge 100a may be referred to as a “front pad edge”.

The plurality of edges 100a, 100b, 100c, and 100d may include a second pad edge 100b. The second pad edge 100b may form other end of the pad 100. For example, the second pad edge 100b may form a rear end of the pad 100. The second pad edge 100b may be positioned opposite the first pad edge 100a. The second pad edge 100b may be referred to as a “rear pad edge”.

The plurality of edges 100a, 100b, 100c, and 100d may include a third pad edge 100c. The third pad edge 100c may form an upper end of the pad 100. The third pad edge 100c may be directed toward or may face the upper cover part 30c (see FIG. 2). The third pad edge 100c may be referred to as an “upper pad edge”.

The plurality of edges 100a, 100b, 100c, and 100d may include a fourth pad edge 100d. The fourth pad edge 100d may be positioned opposite the third pad edge 100c. The fourth pad edge 100d may form a lower end of the pad 100. The fourth pad edge 100d may be directed toward or may face the bottom plate 21 (see FIG. 2). The fourth pad edge 100d may be in contact with or coupled to the heat transfer part 200 (see FIG. 5). The fourth pad edge 100d may be referred to as a “lower pad edge”.

FIG. 8 illustrates a surface of a pad according to an embodiment of the present disclosure.

Referring to FIG. 8. the first pad surface 105 of the pad 100 can be observed. The pad 100 may include a pad body 110. The pad body 110 may have elasticity. For example, the pad body 110 may be formed of a material including a resin. For example, the pad body 110 may be formed of a material including urethane. The pad body 110 may form at least a portion of the first pad surface 105. The pad body 110 may be an electrically insulator.

The pad 100 may include a heat conduction part 120. The heat conduction part 120 may be coupled to the pad body 110. The heat conduction part 120 may form at least a portion of the first pad surface 105. The heat conduction part 120 may be connected to, for example, the fourth pad edge 100d. The heat conduction part 120 may form a shape extending upwardly from the fourth pad edge 100d. For example, the heat conduction part 120 may include a vertical heat conduction part 121 of a shape extending in an up-down direction. The heat conduction part 120 may be an electrically insulator.

A plurality of heat conduction parts 120 may be provided. The plurality of heat conduction parts 120 may be spaced apart from each other. For example, the plurality of heat conduction parts 120 may be sequentially disposed between the first pad edge 100a and the second pad edge 100b. For example, the first pad edge 100a, the plurality of heat conduction parts 120, and the second pad edge 100b may be sequentially disposed.

The heat conduction part 120 may have thermal conductivity. For example, the heat conduction part 120 may include a heat conductive resin. For example, the heat conduction part 120 may include a gap filler. For example, the heat conduction part 120 may include a heat conductive resin. For example, the heat conduction part 120 may include at least one of a silicone-based resin and a polyurethane resin.

The heat conduction part 120 may be in contact with the battery cell 11 (see FIG. 4). At least a portion of heat emitted from the battery cell 11 (see FIG. 4) may be transferred to the heat conduction part 120. At least a portion of the heat transferred to the heat conduction part 120 may be transferred to the heat transfer part 200 (see FIG. 5). At least a portion of the heat transferred to the heat transfer part 200 (see FIG. 5) may be transferred to the bottom plate 21 (see FIG. 5). At least a portion of the heat transferred to the bottom plate 21 (see FIG. 5) may be discharged to the outside.

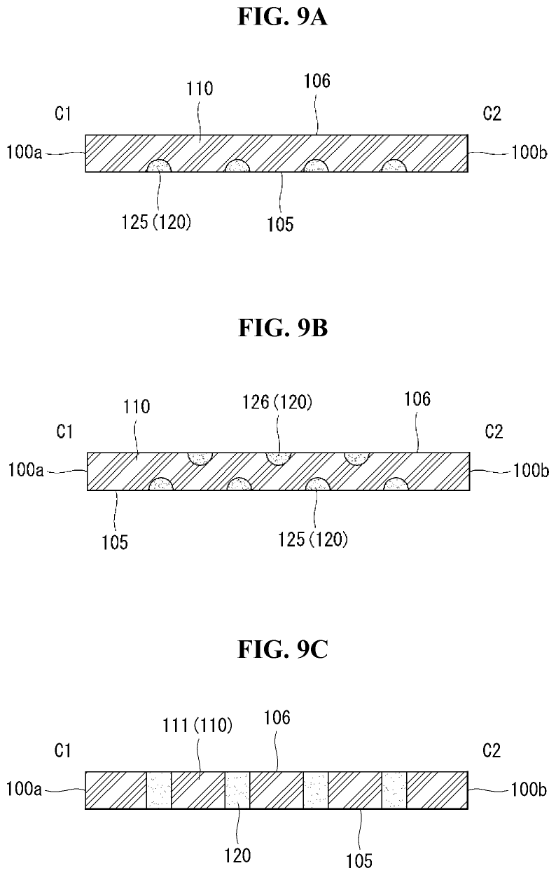

FIGS. 9A to 9C illustrate a cross section taken along C1-C2 of the pad 100 of FIG. 8.

Referring to FIG. 9A, the plurality of heat conduction parts 120 may form a portion of the first pad surface 105. For example, the heat conduction part 120 may include a first heat conduction part 125 that forms a portion of the first pad surface 105 and is spaced apart from the second pad surface 106.

A process of forming the pad 100 can be viewed. A concave groove may be formed in the first pad surface 105 of the pad body 110. The heat conduction part 120 may be disposed in the groove formed in the first pad surface 105 of the pad body 110. The groove formed in the first pad surface 105 may be referred to as a “first groove”.

The heat conduction part 120 in a liquid state may be applied to the pad body 110 and then hardened. The heat conduction part 120 may include a hardener. The heat conduction part 120 may be coupled to the pad body 110.

Referring to FIG. 9B, at least one first heat conduction part 125 may form a portion of the first pad surface 105. The heat conduction part 120 may include a second heat conduction part 126. At least one second heat conduction part 126 may be some of the plurality of heat conduction parts 120. For example, the second heat conduction part 126 may form a portion of the second pad surface 106 and may be spaced apart from the first pad surface 105.

One second heat conduction part 126 may be positioned between the two adjacent first heat conduction parts 125. For example, one second heat conduction part 126 may be disposed on the second pad surface 106 at a position where a point between the two adjacent first heat conduction parts 125 is projected onto the second pad surface 106.

One first heat conduction part 125 may be positioned between the two adjacent second heat conduction parts 126. For example, one first heat conduction part 125 may be disposed on the first pad surface 105 at a position where a point between the two adjacent second heat conduction parts 126 is projected onto the first pad surface 105.

That is, the plurality of first heat conduction parts 125 and the plurality of second heat conduction parts 126 may be arranged in a zigzag shape. For example, the plurality of first heat conduction parts 125 and the plurality of second heat conduction parts 126 may be alternately disposed between the first pad edge 100a and the second pad edge 100b. Through this arrangement, the elasticity of the pad body 110 can be easily maintained.

The process of forming the pad 100 can be viewed. Concave grooves may be respectively formed on the first pad surface 105 and the second pad surface 106 of the pad body 110. The heat conduction part 120 may be applied to the groove formed in the pad body 110. The groove formed in the second pad surface 106 may be referred to as a “second groove”.

Referring to FIG. 9C, the plurality of heat conduction parts 120 may be provided. Each of at least a portion of the plurality of heat conduction parts 120 may extend from the first pad surface 105 and lead to the second pad surface 106. The pad body 110 may be divided into a plurality of segments by the plurality of heat conduction parts 120. The plurality of segments divided from the pad body 110 may be referred to as “a plurality of pad body segments”.

For example, the plurality of heat conduction parts 120 and a plurality of pad body segments 111 may be alternately disposed. For example, the plurality of heat conduction parts 120 and the plurality of pad body segments 111 may be alternately disposed in a direction from the first pad edge 100a to the second pad edge 100b.

With reference to FIGS. 9A to 9C, the process of forming the pad 100 can be viewed. The plurality of pad body segments 111 may be disposed to be spaced apart from each other between the two adjacent battery cells 11 (see FIG. 2). For example, the plurality of pad body segments 111 spaced apart from each other may be attached to the two adjacent battery cells 11 (see FIG. 2). In this state, a gap may be formed between the two adjacent pad body segments 111, or a gap may be formed between the pad body segment 111 and the side plates 25 and 26 (see FIG. 2). When the heat conduction part 120 in the liquid state is injected into the gap and hardens, the heat conduction part 120 of a solid state may be formed.

Another process of forming the pad 100 can be viewed. The pad body 110 with the groove may be disposed between both battery cells 11 (see FIG. 2). In this state, when the heat conduction part 120 in the liquid state is injected into the groove formed in the pad body 110 and hardens, the heat conduction part 120 of a solid state may be formed.

Another process of forming the pad 100 can be viewed. The plurality of pad body segments 111 may be disposed to be spaced apart from each other on a work table. The heat conduction part 120 of the liquid state may be applied and hardened between the two adjacent pad body segments 111 or next to the pad body segment 111. The heat conduction part 120 may include an adhesive component. Thus, the plurality of heat conduction parts 120 may be coupled to the plurality of pad body segments 111.

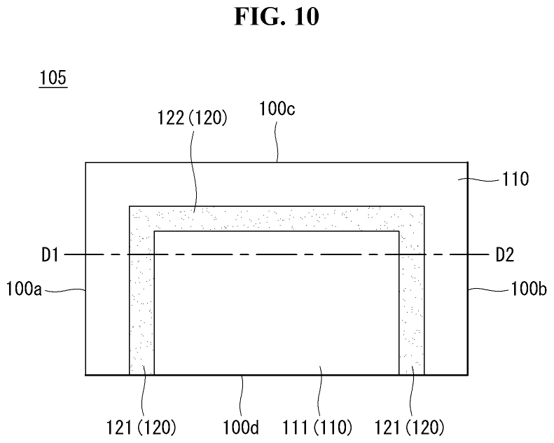

FIG. 10 illustrates a pad including a horizontal heat conduction part.

Referring to FIG. 10, the heat conduction part 120 may include a vertical heat conduction part 121 and a horizontal heat conduction part 122. The vertical heat conduction part 121 may form a shape extending upwardly from the fourth pad edge 100d. A plurality of vertical heat conduction parts 121 may be provided. The plurality of vertical heat conduction parts 121 may be sequentially disposed between the first pad edge 100a and the second pad edge 100b. For example, the first pad edge 100a, the plurality of vertical heat conduction parts 121, and the second pad edge 100b may be sequentially disposed.

The horizontal heat conduction part 122 may form a shape extending in a horizontal direction. For example, the horizontal heat conduction part 122 may form a shape extending in a direction from the first pad edge 100a to the second pad edge 100b. For example, one end of the horizontal heat conduction part 122 may be adjacent to the first pad edge 100a, and other end of the horizontal heat conduction part 122 may be adjacent to the second pad edge 100b. The horizontal heat conduction part 122 may extend from its one end and lead to its other end. One end of the horizontal heat conduction part 122 may be connected to one vertical heat conduction part 121, and other end of the horizontal heat conduction part 122 may be connected to another vertical heat conduction part 121. The horizontal heat conduction part 122 may connect the two vertical heat conduction parts 121.

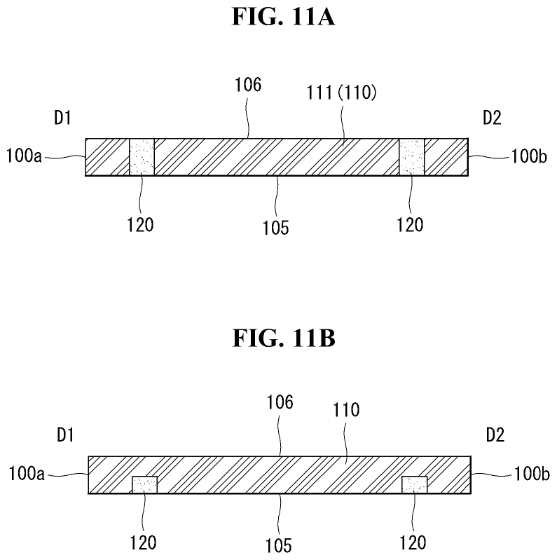

FIGS. 11A and 11B illustrate a cross section taken along D1-D2 of the pad 100 of FIG. 10.

Referring to FIG. 11A, the heat conduction part 120 may extend from the first pad surface 105 and lead to the second pad surface 106. That is, the heat conduction part 120 may receive heat from the battery cell 11 (see FIG. 2) in contact with the first pad surface 105 and the battery cell 11 (see FIG. 2) in contact with the second pad surface 106.

Referring to FIG. 11B, the heat conduction part 120 may form a portion of the first pad surface 105. The heat conduction part 120 may be spaced apart from the second pad surface 106. That is, most of the heat transferred to the heat conduction part 120 may result from the battery cell 11 (see FIG. 2) in contact with the first pad surface 105.

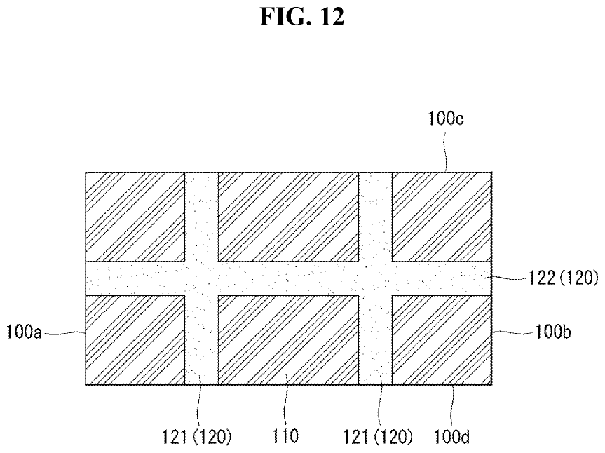

FIG. 12 illustrates a pad in which a horizontal heat conduction part and a vertical heat conduction part intersect each other. Further, FIG. 12 illustrates a cross section of the pad 100.

Referring to FIG. 12, a plurality of vertical heat conduction parts 121 may be provided. The vertical heat conduction part 121 may be connected to or in contact with the fourth pad edge 100d. The plurality of vertical heat conduction parts 121 may be sequentially disposed between the first pad edge 100a and the second pad edge 100b. For example, the first pad edge 100a, the plurality of vertical heat conduction parts 121, and the second pad edge 100b may be sequentially disposed.

The horizontal heat conduction part 122 may intersect the vertical heat conduction part 121. The horizontal heat conduction part 122 may be formed to extend in a direction from the first pad edge 100a to the second pad edge 100b.

Referring to FIGS. 7 to 12, the pad body 110 may form at least a portion of the first pad surface 105 and at least a portion of the second pad surface 106. The heat conduction part 120 may form at least a portion of the first pad surface 105. That is, the pad body 110 and the heat conduction part 120 may each form a layer and form a single layer instead of a combined shape. Thus, the pad 100 according to an embodiment of the present disclosure may be formed to be relatively slim, and the more battery cells 11 may be accommodated in the housing 20 (see FIG. 2). That is, the space efficiency of the battery module 1 can increase.

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

What is claimed is:

1. A cell assembly comprising:
a plurality of battery cells; and
a pad disposed between the plurality of battery cells, the pad including a first pad surface and a second pad surface positioned opposite the first pad surface,
wherein the pad includes:
a pad body with an elasticity; and
a heat conduction part coupled to the pad body and connected to an edge of the pad, the heat conduction part having a thermal conductivity,
wherein the pad body forms at least a portion of the first pad surface, and
wherein the pad body forms at least a portion of the second pad surface.

2. The cell assembly of claim 1, wherein the edge of the pad forms a lower end of the pad, and
wherein the heat conduction part includes a vertical heat conduction part extending upwardly from an edge of the pad body.

3. The cell assembly of claim 2, wherein the heat conduction part further includes a horizontal heat conduction part connected to the vertical heat conduction part, and
wherein the horizontal heat conduction part extends in a direction crossing the vertical heat conduction part.

4. The cell assembly of claim 3, wherein the vertical heat conduction part includes a plurality of vertical heat conduction parts that are spaced apart from each other, and
wherein the horizontal heat conduction part connects respective ends of the plurality of vertical heat conduction parts.

5. The cell assembly of claim 3, wherein the horizontal heat conduction part intersects the vertical heat conduction part.

6. The cell assembly of claim 1, wherein the pad body includes a first groove of a recessed shape in the first pad surface, and
wherein the heat conduction part includes a first heat conduction part that is positioned in the first groove and forms at least a portion of the first pad surface.

7. The cell assembly of claim 6, wherein the pad body includes a second groove of a recessed shape in the second pad surface, and
wherein the heat conduction part includes a second heat conduction part that is positioned in the second groove and forms at least a portion of the second pad surface.

8. The cell assembly of claim 7, wherein the first groove includes a plurality of first grooves,
wherein the first heat conduction part includes a plurality of first heat conduction parts respectively positioned in the plurality of first grooves, and
wherein the second heat conduction part is positioned between two adjacent first heat conduction parts among the plurality of first heat conduction parts.

9. The cell assembly of claim 8, wherein the second heat conduction part is disposed at a position where a point between the two adjacent first heat conduction parts is projected onto the second pad surface.

10. The cell assembly of claim 1, wherein the heat conduction part extends from the first pad surface and leads to the second pad surface.

11. The cell assembly of claim 1, wherein the heat conduction part includes at least one of a silicone-based resin and a polyurethane resin.

12. A battery module comprising:
a battery group including a plurality of battery cells;
a housing configured to accommodate the battery group; and
a pad disposed between the plurality of battery cells, the pad including a first pad surface and a second pad surface positioned opposite the first pad surface,
wherein the pad includes:
a pad body with an elasticity, the pad body being configured to form at least a portion of the first pad surface and form at least a portion of the second pad surface; and
a heat conduction part coupled to the pad body and connected to an edge of the pad, the heat conduction part having a thermal conductivity.

13. The battery module of claim 12, wherein the housing includes a bottom plate that forms a bottom of the housing and is positioned under the pad,
wherein the edge of the pad faces the bottom plate.

14. The battery module of claim 13, further comprising:
a heat transfer part positioned between the pad and the bottom plate and configured to couple the pad to the bottom plate.

15. The battery module of claim 14, wherein the pad is disposed between two adjacent battery cells among the plurality of battery cells,
wherein at least a portion of a heat generated in at least one of the two adjacent battery cells is transferred to the heat conduction part,
wherein at least a portion of the heat transferred to the heat conduction part is transferred to the heat transfer part, and
wherein at least a portion of the heat transferred to the heat transfer part is transferred to the bottom plate.

16. The battery module of claim 14, wherein each of the heat conduction part and the heat transfer part includes at least one of a silicone-based resin and a polyurethane resin.

17. The battery module of claim 12, wherein the pad body is disposed between two adjacent battery cells among the plurality of battery cells, and
wherein the heat conduction part in a liquid state is injected into between the two adjacent battery cells and hardens to be coupled to the pad body and the two adjacent battery cells.

18. The battery module of claim 12, wherein the pad body is disposed between two adjacent battery cells among the plurality of battery cells and includes a groove and includes a groove formed in at least one of the first pad surface and the second pad surface, and
wherein the heat conduction part in a liquid state is injected into the groove and hardens to be coupled to the battery cell facing the pad body and the groove.

19. The battery module of claim 12, wherein the pad is disposed between two adjacent battery cells among the plurality of battery cells,
wherein the first pad surface is attached or coupled to one of the two adjacent battery cells, and
wherein the second pad surface is attached or coupled to the other of the two adjacent battery cells.

20. The battery module of claim 12, wherein the housing includes:
a bottom plate configured to form a bottom of the housing and positioned under the pad; and
side plates respectively extending upwardly from both edges of the bottom plate that face each other,
wherein the bottom plate is formed of a material including aluminum, and
wherein the side plates are formed of a material including a thermal insulation material.
